(19) United States
(12) Patent Application Publication
(10) Pub. No.: US 2026/0196703 A1
(43) Pub. Date: Jul. 9, 2026

(54) PHASE SHIFTER AND ANTENNA

(71) Applicants: Beijing BOE Technology Development Co., Ltd., Beijing (CN); BOE Technology Group Co., Ltd., Beijing (CN)

(72) Inventors: Jia FANG, Beijing (CN); Yang ZHENG, Beijing (CN); Feng QU, Beijing (CN)

(21) Appl. No.: 18/729,921

(22) PCT Filed: Apr. 21, 2023
(86) PCT No.: PCT/CN2023/089893

§ 371 Date: Jul. 18, 2024

(51) Int. Cl. H01P 1/18; H01Q 3/36

(52) U.S. Cl. CPC H01P 1/18; H01Q 3/36

(57) ABSTRACT

Disclosed are a phase shifter and an antenna. The phase shifter includes a first substrate and a second substrate arranged opposite to each other, and a dielectric layer between the first substrate and the second substrate. The first substrate includes a first base, a first flexible substrate at a side of the first base close to the dielectric layer, and a first electrode layer at a side of the first flexible layer close to the dielectric layer. The second substrate includes a second base, a second flexible substrate at a side of the second base close to the dielectric layer, and a second electrode layer at a side of the second flexible layer close to the dielectric layer. A dielectric constant of the first base and a dielectric constant of the second base both are smaller than or equal to 1.5.

### CROSS-REFERENCE TO RELATED APPLICATIONS

This application is a National Stage of International Application No. PCT/CN2023/089893, filed on Apr. 21, 2023, all of which is hereby incorporated by reference in its entirety.

### TECHNICAL FIELD

The disclosure relates to the field of communication technology, in particular to a phase shifter and an antenna.

### BACKGROUND

A phase shifter is a device that can adjust the phase of microwave signals, which is widely used in electronic communication systems and is the core component of phased array radar, synthetic aperture radar, electronic countermeasures radar, satellite communications, receivers and transmitters. Therefore, high-performance phase shifters play a critical role in these systems.

### SUMMARY

The disclosure provides a phase shifter and an antenna. A specific solution is as follows.

A phase shifter provided in embodiments of the disclosure includes a first substrate and a second substrate arranged opposite to each other, and a dielectric layer between the first substrate and the second substrate. The first substrate includes a first base, a first flexible substrate at a side of the first base close to the dielectric layer, and a first electrode layer at a side of the first flexible layer close to the dielectric layer. The second substrate includes a second base, a second flexible substrate at a side of the second base close to the dielectric layer, and a second electrode layer at a side of the second flexible layer close to the dielectric layer. A dielectric constant of the first base and a dielectric constant of the second base both are smaller than or equal to 1.5.

In a possible implementation, in the phase shifter provided in the embodiments of the disclosure, the first substrate further includes a first voltage line between the first flexible substrate and the first electrode layer, and the second substrate further includes a second voltage line between the second flexible substrate and the second electrode layer. The first voltage line is electrically connected with the first electrode layer, and the second voltage line is electrically connected with the second electrode layer.

In a possible implementation, in the phase shifter provided in the embodiments of the disclosure, a material of the first voltage line and a material of the second voltage line both are a transparent conducting material; and the first voltage line is electrically connected with the first electrode layer via direct contact, and the second voltage line is electrically connected with the second electrode layer via direct contact.

In a possible implementation, in the phase shifter provided in the embodiments of the disclosure, the first voltage line is electrically connected with the first electrode layer at edges of both, and a width of an overlap between an orthographic projection of the first voltage line on the first base and an orthographic projection of the first electrode layer on the first base is larger than 1 μm; and the second voltage line is electrically connected with the second electrode layer at edges of both, and a width of an overlap between an orthographic projection of the second voltage line on the second base and an orthographic projection of the second electrode layer on the second base is larger than 1 μm.

In a possible implementation, in the phase shifter provided in the embodiments of the disclosure, a material of the first voltage line and a material of the second voltage line both are metal. The first substrate further includes a first insulating layer between the first voltage line and the first electrode layer, and the second substrate further includes a second insulating layer between the second voltage line and the second electrode layer. The first voltage line is electrically connected with the first electrode layer through a first via hole passing through the first insulating layer, and the second voltage line is electrically connected with the second electrode layer through a second via hole passing through the second insulating layer.

In a possible implementation, in the phase shifter provided in the embodiments of the disclosure, a shape of the first via hole and a shape of the second via hole both are annular.

In a possible implementation, in the phase shifter provided in the embodiments of the disclosure, the first electrode layer is ground electrode set over an entire surface, and the second electrode layer includes a micro-strip line.

In a possible implementation, in the phase shifter provided in the embodiments of the disclosure, the micro-strip line has a grid-like structure.

In a possible implementation, in the phase shifter provided in the embodiments of the disclosure, a spacing between grid lines of the grid-like structure is less than or equal to 100 μm, and a width of the grid line ranges from 1 μm to 20 μm.

In a possible implementation, the phase shifter provided in the embodiments of the disclosure further includes a first transparent conducting layer at a side of the second electrode layer facing or facing away from the first electrode layer and in contact with the second electrode layer; where an orthographic projection of the first transparent conducting layer on the second base covers an orthographic projection of the micro-strip line on the second base.

In a possible implementation, in the phase shifter provided in the embodiments of the disclosure, the first electrode layer includes a first ground electrode, a first signal electrode, and a second ground electrode extending along a first direction and spaced apart along a second direction; the second electrode layer includes a plurality of second signal electrodes extending along the second direction and spaced apart along the first direction; an orthographic projection of each second signal electrode on the first base at least partially overlaps with an orthographic projection of the first ground electrode on the first base, and at least partially overlaps with an orthographic projection of the second ground electrode on the first base.

In a possible implementation, in the phase shifter provided in the embodiments of the disclosure, the first ground electrode, the first signal electrode, the second ground electrode, and the second signal electrode all includes a grid-like structure.

In a possible implementation, in the phase shifter provided in the embodiments of the disclosure, mesh openings of each grid-like structure have the same size, and grid lines of each grid-like structure have the same width.

In a possible implementation, in the phase shifter provided in the embodiments of the disclosure, a mesh density in an overlapping region between the second signal electrode and the first signal electrode is greater than or equal to a mesh density in other regions.

In a possible implementation, in the phase shifter provided in the embodiments of the disclosure, a spacing between grid lines in the overlapping region between the second signal electrode and the first signal electrode is less than 20 μm.

In a possible implementation, in the phase shifter provided in the embodiments of the disclosure, the orthographic projection of the second signal electrode on the first base and an orthographic projection of the first signal electrode on the first base have an overlapping region; the phase shifter further includes: a second transparent conducting layer at a side of the first signal electrode facing or facing away from the second electrode layer and in contact with the first signal electrode; where an orthographic projection of the second transparent conducting layer on the first base covers an orthographic projection of the overlapping region on the first base; and the phase shifter further includes: a third transparent conducting layer at a side of the second signal electrode facing or facing away from the first electrode layer and in contact with the second signal electrode; where an orthographic projection of the third transparent conducting layer on the first base covers an orthographic projection of the overlapping region on the first base.

In a possible implementation, in the phase shifter provided in the embodiments of the disclosure, the second signal electrode and the first signal electrode are not hollowed-out in the overlapping region.

In a possible implementation, in the phase shifter provided in the embodiments of the disclosure, the first electrode layer includes a first differential transmission line and a second differential transmission line extending along a first direction and spaced apart along a second direction; the second electrode layer includes a plurality of signal electrodes extending along the second direction and spaced apart along the first direction; and an orthographic projection of each signal electrode on the first base at least partially overlaps with an orthographic projection of the first differential transmission line on the first base, and at least partially overlaps with an orthographic projection of the second differential transmission line on the first base.

In a possible implementation, in the phase shifter provided in the embodiments of the disclosure, the first differential transmission line includes a first main structure and a plurality of first branches connected with the first main structure and spaced apart at a side of the first main structure facing the second differential transmission line; the second differential transmission line includes a second main structure and a plurality of second branches connected with the second main structure and spaced apart at a side of the second main structure facing the first differential transmission line; and the plurality of first branches correspond to the plurality of second branches in a one-to-one manner, and an orthographic projection of each signal electrode on the first base at least covers orthographic projections of a pair of first branch and second branch on the first base.

In a possible implementation, in the phase shifter provided in the embodiments of the disclosure, at least one of the first differential transmission line, the second differential transmission line, or the signal electrode includes a grid-like structure.

In a possible implementation, in the phase shifter provided in the embodiments of the disclosure, both the first base and the second base have at least one hollowed-out structure; or both the first base and the second base have a plurality of hollowed-out structures distributed uniformly.

In a possible implementation, in the phase shifter provided in the embodiments of the disclosure, a material of the first base and a material of the second base both include polymethacrylimide (PMI).

In a possible implementation, in the phase shifter provided in the embodiments of the disclosure, a thickness of the first base and a thickness of the second base both range from 0.5 mm to 3 mm.

In a possible implementation, in the phase shifter provided in the embodiments of the disclosure, a material of the first flexible substrate and a material of the second flexible substrate include polyimide (PI), cycloolefin polymers (COP), or polyethylene terephthalate (PET).

In a possible implementation, in the phase shifter provided in the embodiments of the disclosure, a thickness of the first flexible substrate and a thickness of the second flexible substrate both range from 1 μm to 20 μm.

Correspondingly, embodiments of the disclosure further provide an antenna including the phase shifter provided in the embodiments of the disclosure.

### BRIEF DESCRIPTION OF FIGURES

FIG. 1 is a schematic structural diagram of a phase shifter provided in embodiments of the disclosure.

FIG. 2 is another schematic structural diagram of a phase shifter provided in embodiments of the disclosure.

FIG. 3 is another schematic structural diagram of a phase shifter provided in embodiments of the disclosure.

FIG. 4 is a schematic planar diagram of a region of a first via hole in FIG. 3.

FIGS. 5A-5J are schematic structural diagrams corresponding to the manufacturing flow of the phase shifter provided in the embodiments of the disclosure.

FIGS. 6A-6D are schematic structural diagrams corresponding to the manufacturing flow of the phase shifter provided in the embodiments of the disclosure.

FIG. 7 is a schematic structural diagram of a micro-strip line.

FIG. 8 is another schematic structural diagram of a micro-strip line.

FIG. 9 is a schematic structural diagram of a micro-strip line covered by a first transparent conducting layer.

FIG. 10 is a schematic planar diagram of a first electrode layer and a second electrode layer in FIGS. 2-3.

FIG. 11 is another schematic planar diagram of a first electrode layer and a second electrode layer in FIGS. 2-3.

FIG. 12 is an enlarged view of a dashed box in FIG. 11.

FIG. 13 is another schematic planar diagram of a first electrode layer and a second electrode layer in FIGS. 2-3.

FIG. 14 is an enlarged view of a dashed box in FIG. 13.

FIG. 15 is another schematic planar diagram of a first electrode layer and a second electrode layer in FIGS. 2-3.

FIG. 16 is another schematic planar diagram of a first electrode layer and a second electrode layer in FIGS. 2-3.

FIG. 17 is another schematic planar diagram of a first electrode layer and a second electrode layer in FIGS. 2-3.

FIG. 18 is another schematic planar diagram of a first electrode layer and a second electrode layer in FIGS. 2-3.

FIG. 19 is another schematic structural diagram of a phase shifter provided in embodiments of the disclosure.

FIG. 20 is a schematic planar diagram of a hollow structure of a first substrate as an example.

### DETAILED DESCRIPTION

In order to make the objectives, technical solutions, and advantages of embodiments of the disclosure clearer, the technical solutions of the embodiments of the disclosure will be described clearly and completely in conjunction with accompanying drawings of the embodiments of the disclosure. Obviously, the described embodiments are some, not all, of the embodiments of the disclosure. In addition, the embodiments and features in the embodiments of the disclosure may be combined with each other without conflict. Based on the described embodiments of the disclosure, all other embodiments obtained by those of ordinary skill in the art without the need for creative labor fall within the scope of protection of the disclosure.

Unless otherwise defined, technical or scientific terms used in the disclosure shall have the common meanings understood by those of ordinary skill in the art to which the disclosure belongs. “Include” or “comprise” and other similar words mean that an element or item appearing before the word encompasses elements or items listed after the word and their equivalents, without excluding other elements or items. “Connect” or “link” and other similar words are not limited to physical or mechanical connections, but may include electrical connections, whether direct or indirect. “Inner”, “outer”, “up”, “down”, etc., are only used to indicate the relative position relationship. When an absolute position of a described object changes, the relative position relationship may also change accordingly.

It should be noted that the size and shape of each figure in the accompanying drawings do not reflect a true scale, but are only intended to illustrate the content of the disclosure. The same or similar reference numerals indicate the same or similar elements or elements with the same or similar functions throughout.

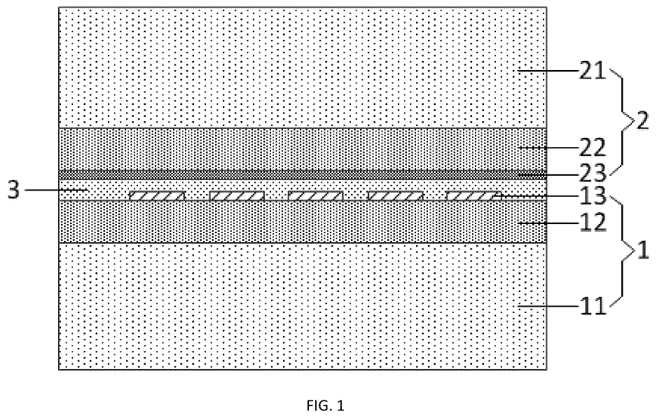

Embodiments of the disclosure provide a phase shifter, as shown in FIG. 1, including: a first substrate 1 and a second substrate 2 arranged opposite to each other, and a dielectric layer 3 between the first substrate 1 and the second substrate 2.

Here, the first substrate 1 includes a first base 11, a first flexible substrate 12 at a side of the first base 11 close to the dielectric layer 3, and a first electrode layer 13 at a side of the first flexible substrate 12 close to the dielectric layer 3.

The second substrate 2 includes a second base 21, a second flexible substrate 22 at a side of the second base 21 close to the dielectric layer 3, and a second electrode layer 23 at a side of the second flexible substrate 22 close to the dielectric layer 3.

Here, a dielectric constant of the first base 11 and a dielectric constant of the second base 21 both are smaller than or equal to 1.5.

According to the phase shifter provided in the embodiments of the disclosure, both the first substrate and the second substrate adopt low dielectric constant layers and flexible layers. On the one hand, since the dielectric constant of low dielectric constant materials is usually close to that of air, for microwave signals, the equivalent dielectric constant depends largely on the dielectric layer, thereby greatly improving the tuning efficiency of the phase shifter. On the other hand, the loss of low dielectric constant layers is much lower than that of materials such as glass and a printed circuit board (PCB), resulting in extremely low dielectric losses during transmission. Therefore, the tuning efficiency of the phase shifter provided by the embodiments of the disclosure can be greatly improved, and the loss can be greatly reduced.

Using low-loss phase shifters can avoid the use of waveguide structures, greatly reduce the weight and longitudinal size of the antenna array, and achieve an extremely low-profile phase shifter.

As shown in FIG. 1, the dielectric constant of the dielectric layer 3 can be changed according to the change of the electric field between the first electrode layer 13 and the second electrode layer 23. Specifically, the dielectric layer 3 can be a liquid crystal layer 3. The liquid crystal, as an anisotropic material, has different dielectric constants along the long and short axes. When a bias voltage is applied to both sides of the liquid crystal, the liquid crystal undergoes deflection, causing the dielectric constant of the liquid crystal material to change with the change of the bias voltage in a certain direction. Of course, the dielectric layer 3 disclosed herein can also be other materials, similar to liquid crystals, whose dielectric constant can be changed based on changes in the electric field. The disclosure is illustrated herein taking the dielectric layer 3 as the liquid crystal layer 3.

Specifically, as shown in FIG. 1, after applying voltages to the first electrode layer 13 and the second electrode layer 23, an electric field is formed between them to cause the liquid crystal molecules in the liquid crystal layer 3 to deflect, thereby changing the dielectric constant of the liquid crystal layer 3 to alter the phase of the microwave signal transmitted to the liquid crystal layer 3, so that the phase shifting is realized.

In specific implementations, in the phase shifter provided in the embodiments of the disclosure, as shown in FIG. 1, the materials of the first base 11 and the second base 21 may include, but are not limited to, polymethacrylimide (PMI). Optionally, a thickness of the first base 11 and a thickness of the second base 21 may both range from 0.5 mm to 3 mm.

In specific implementations, in the phase shifter provided in the embodiments of the disclosure, as shown in FIG. 1, the materials of the first flexible substrate 12 and the second flexible substrate 22 may include, but are not limited to, polyimide (PI), cycloolefin polymers (COP), or polyethylene terephthalate (PET). Optionally, a thickness of the first flexible substrate 12 and a thickness of the second flexible substrate 22 may both range from 1 μm to 20 μm.

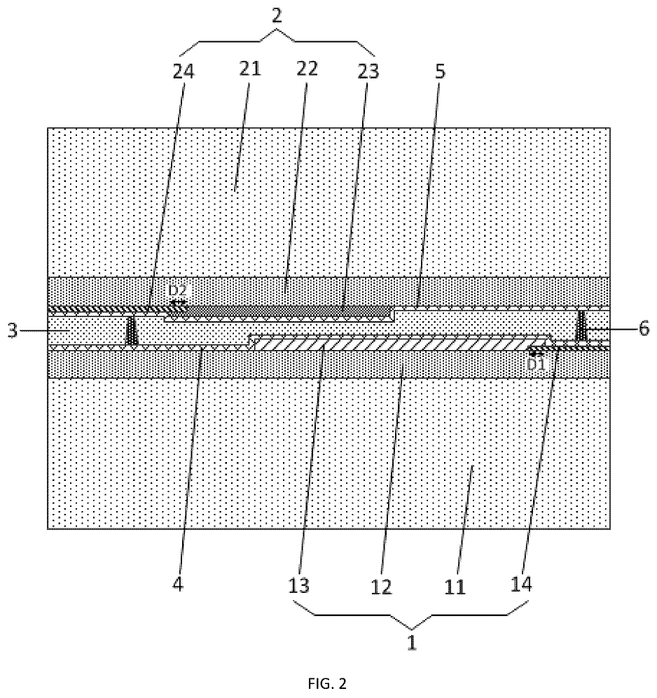

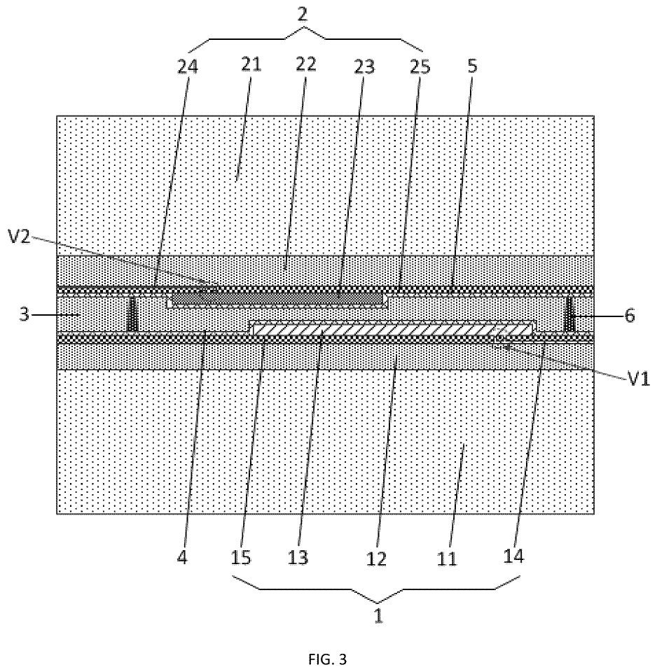

In specific implementations, in the phase shifter provided in the embodiments of the disclosure, as shown in FIGS. 2 and 3, the first substrate 1 further includes a first voltage line 14 between the first flexible substrate 12 and the first electrode layer 13, and the second substrate 2 further includes a second voltage line 24 between the second flexible substrate 22 and the second electrode layer 23.

Here, the first voltage line 14 is electrically connected with the first electrode layer 13, and the second voltage line 24 is electrically connected with the second electrode layer 23. In this way, by applying a voltage to the first electrode layer 13 via the first voltage line 14 and applying a voltage to the second electrode layer 23 via the second voltage line 24, a voltage difference is formed between the first electrode layer 13 and the second electrode layer 23, driving the liquid crystal molecules in the liquid crystal layer 3 to deflect, changing the dielectric constant of the liquid crystal layer 3, and altering the phase of the microwave signal transmitted to the liquid crystal layer 3.

In specific implementations, in the phase shifter provided in the embodiments of the disclosure, as shown in FIG. 2, the materials of the first voltage line 14 and the second voltage line 24 may both be transparent conducting materials. The first voltage line 14 is electrically connected with the first electrode layer 13 via direct contact, and the second voltage line 24 is electrically connected with the second electrode layer 23 via direct contact. Optionally, the materials of the first voltage line 14 and the second voltage line 24 may include, but are not limited to, indium tin oxide (ITO). Since the conductivity of ITO is two orders of magnitude lower than that of metal materials, leakage of microwave signals can be avoided by designing the width of the ITO lines reasonably, typically ranging from 5 μm to 50 μm.

In specific implementations, in the phase shifter provided in the embodiments of the disclosure, as shown in FIG. 2, the first voltage line 14 may be electrically connected with the first electrode layer 13 at edges of both. To ensure that the voltage can be applied to the first electrode layer 13, a width D1 of an overlap between an orthographic projection of the first voltage line 14 on the first base 11 and an orthographic projection of the first electrode layer 13 on the first base 11 is greater than 1 μm.

The second voltage line 24 may be electrically connected with the second electrode layer 23 at edges of both. To ensure that the voltage can be applied to the second electrode layer 23, a width D2 of an overlap between an orthographic projection of the second voltage line 24 on the second base 21 and an orthographic projection of the second electrode layer 23 on the second base 21 is greater than 1 μm.

In specific implementations, in the phase shifter provided in the embodiments of the disclosure, as shown in FIG. 3, the materials of the first voltage line 14 and the second voltage line 24 may be metal. Due to the high conductivity of metal, the voltage loss on the first voltage line 14 and the second voltage line 24 can be reduced.

However, since the high conductivity of the metal can easily cause leakage of microwave signals, resulting in additional transmission loss, the disclosure can employ an interlayer transmission method. For example, the first substrate 1 further includes a first insulating layer 15 between the first voltage line 14 and the first electrode layer 13, and the second substrate 2 further includes a second insulating layer 25 between the second voltage line 24 and the second electrode layer 23.

Here, the first voltage line 14 is electrically connected with the first electrode layer 13 through a first via hole V1 passing through the first insulating layer 15, and the second voltage line 24 is electrically connected with the second electrode layer 23 through a second via hole V2 passing through the second insulating layer 25. Specifically, a thickness of the first insulating layer 15 and a thickness of the second insulating layer 25 should not affect the device performance, but the thickness should not be less than 20 nm to ensure insulation. Preferably, the thickness of the first insulating layer 15 and the thickness of the second insulating layer 25 are each 50 nm to 200 nm. Via holes in the first insulating layer 15 and the second insulating layer 25 can be formed by patterning and etching. The shapes of the first via hole V1 and the second via hole V2 can be circular, rectangular, or other shapes without affecting the device performance. Then, by depositing a metal layer, conduction based on metal can be achieved, thereby achieving applying voltages to the first electrode layer 13 and the second electrode layer 23. Preferably, sizes of the first via hole V1 and the second via hole V2 are 10 μm to 100 μm to ensure that microwave signals do not leak to the first voltage line 14 and the second voltage line 24.

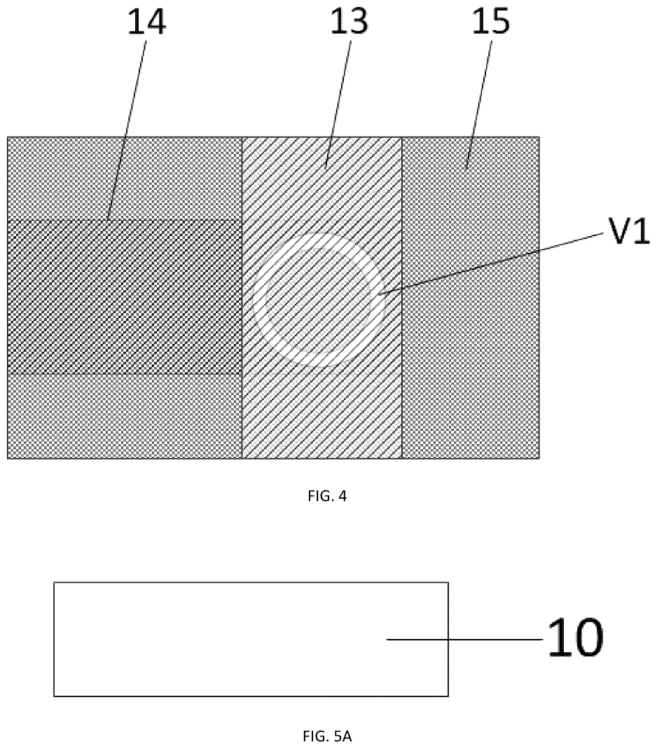

In specific implementations, in the phase shifter provided in the embodiments of the disclosure, as shown in FIG. 3, when the first voltage line 14 and the second voltage line 24 made of metal are prepared using semiconductor thin film processes, they are prepared as whole metal layers and then etched. Therefore, it is very likely that the metal layers will completely fill the via holes (V1 and V2) in the insulating layers, thereby sharply reducing the resistance of the first voltage line 14 and the second voltage line 24. Therefore, preferably, the shapes of the first via hole V1 and the second via hole V2 are annular, with the width of the annulus ranging from 10 μm to 100 μm. Compared to circular or rectangular via holes, annular via holes of this size can greatly increase the impedance of the first voltage line 14 and the second voltage line 24, thereby ensuring that microwave signals do not leak onto the first voltage line 14 and the second voltage line 24. As shown in FIG. 4, a plan view of the region where the first via hole V1 is located in FIG. 3 is illustrated.

In specific implementations, the phase shifter provided in the embodiments of the disclosure, as shown in FIGS. 2 and 3, further includes: a first alignment layer 4 at a side of the first substrate 1 facing the second substrate 2, a second alignment layer 5 at a side of the second substrate 2 facing the first substrate 1, and a spacer layer 6 between the first alignment layer 4 and the second alignment layer 5. Specifically, the first alignment layer 4 and the second alignment layer 5 are used for orienting the initial state of the liquid crystal molecules in the liquid crystal layer 3, and the spacer layer 6 is used for supporting the cell thickness of the phase shifter. The materials of these film layers are the same as those of the prior art, and are not described in detail herein.

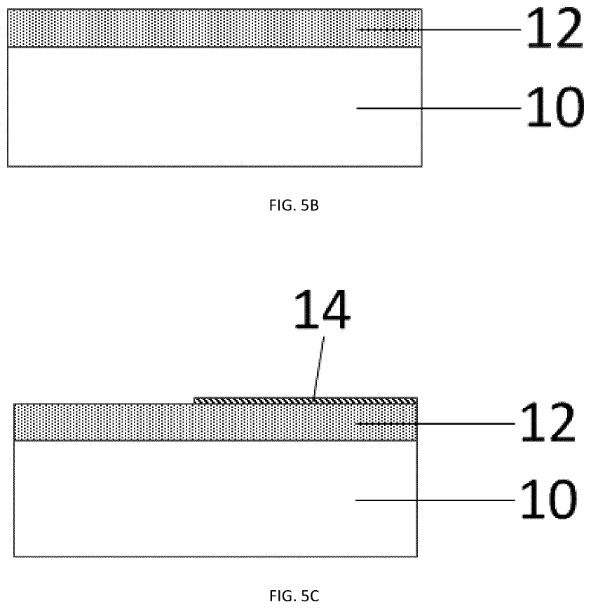

In specific implementations, the phase shifter provided in the embodiments can be prepared using semiconductor display processes. Taking the phase shifter shown in FIG. 3 as an example, the fabrication process of the phase shifter is shown in FIGS. 5A to 5J. Specifically, as shown in FIG. 5A, a glass substrate 10 is provided; as shown in FIG. 5B, a first flexible substrate 12 is formed on the glass substrate 10; as shown in FIG. 5C, a first voltage line 14 is formed on the first flexible substrate 12; as shown in FIG. 5D, a first electrode layer 13 and a first alignment layer (not shown) are formed on the first voltage line 14; as shown in FIG. 5E, a spacer layer 6 is formed on the first alignment layer; as shown in FIG. 5F, a liquid crystal is injected into the structure of FIG. 5E via a liquid crystal infusion process (one drop filling (ODF) or vacuum inject filling (VIF)); similarly, a second flexible substrate 22, a second voltage line 24, a second electrode layer 23, and a second alignment layer (not shown) are sequentially formed on another glass substrate 20, and the liquid crystal is injected, as shown in FIG. 5G; as shown in FIG. 5H, the structures shown in FIG. 5F and FIG. 5G are aligned and laminated to form a liquid crystal cell; as shown in FIG. 51, by peeling (e.g., laser lifting off (LLO)), the glass substrate 10 and the first flexible substrate 12 are separated, and the glass substrate 20 and the second flexible substrate 22 are separated; and as shown in FIG. 5J, the first base 11 with the low dielectric constant is bonded to the first flexible substrate 12, and the second base 21 with the low dielectric constant is bonded to the second flexible substrate 22.

Optionally, the materials of the first electrode layer 13 and the second electrode layer 23 can be copper, gold, silver, or other low-resistance, low-loss metal materials, and can be prepared using methods such as magnetron sputtering, thermal evaporation, electroplating, etc.

Optionally, the glass substrates (10 and 20) can be commonly used PCB insulation materials such as polytetrafluoroethylene glass fiber laminate, phenolic paper laminate, phenolic glass cloth laminate, etc., or rigid materials with low microwave signal loss such as quartz, glass, with a thickness of 100 μm to 10 mm.

Optionally, the cell thickness of the liquid crystal phase shifter can be 3 μm to 250 μm (thickness between the first alignment layer and the second alignment layer).

Optionally, in the embodiments of the disclosure, the voltages can be directly applied to the electrode layers using voltage lines. Alternatively, thin-film transistors (TFTs) can be used to apply voltages to the electrode layers. In this case, TFTs are first prepared on the flexible substrate using multilayer film-forming processes, and then patterned electrode layers are directly deposited, with bias lines only needing to be connected with the TFTs.

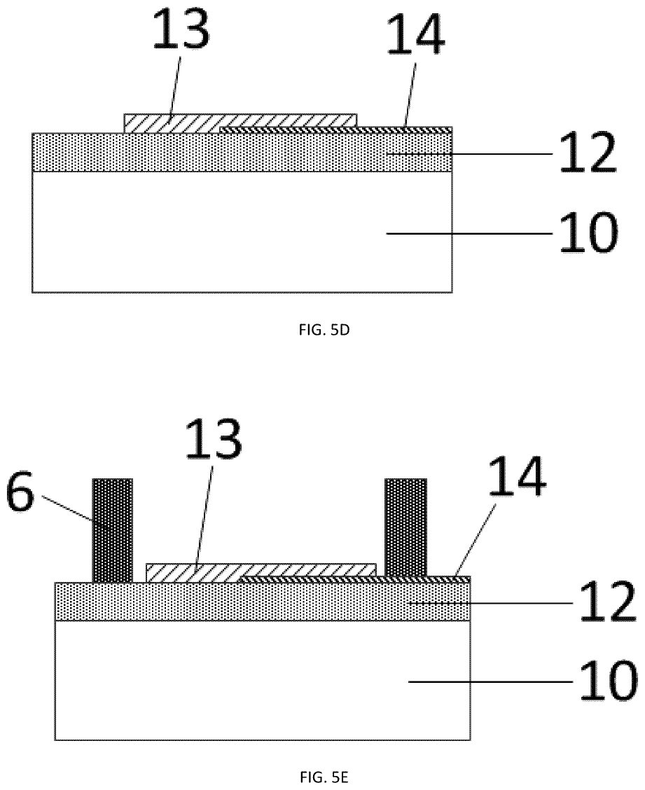

Optionally, the optical adhesive (OCA) or other types of adhesives can be used as bonding agents for bonding the base with the low dielectric constant to the flexible substrate, completing the preparation through a soft-to-hard bonding process. To maximize the product yield, after preparing the liquid crystal cell shown in FIG. 5H, the glass substrate 20 at one side can be peeled off first, as shown in FIG. 6A; as shown in FIG. 6B, the second base 21 with the low dielectric constant is bonded to the second flexible substrate 22; as shown in FIG. 6C, the glass substrate 10 at the other side is then peeled off; and as shown in FIG. 6D, the first base 11 with the low dielectric constant is bonded to the first flexible substrate 12. That is, the liquid crystal phase shifter can be prepared using the process flow shown in FIGS. 5A to 5H, and FIGS. 6A to 6D. This process flow ensures that the liquid crystal cell is always in an environment of rigid substrates, which is a hard-to-hard bonding process, thereby improving the product yield.

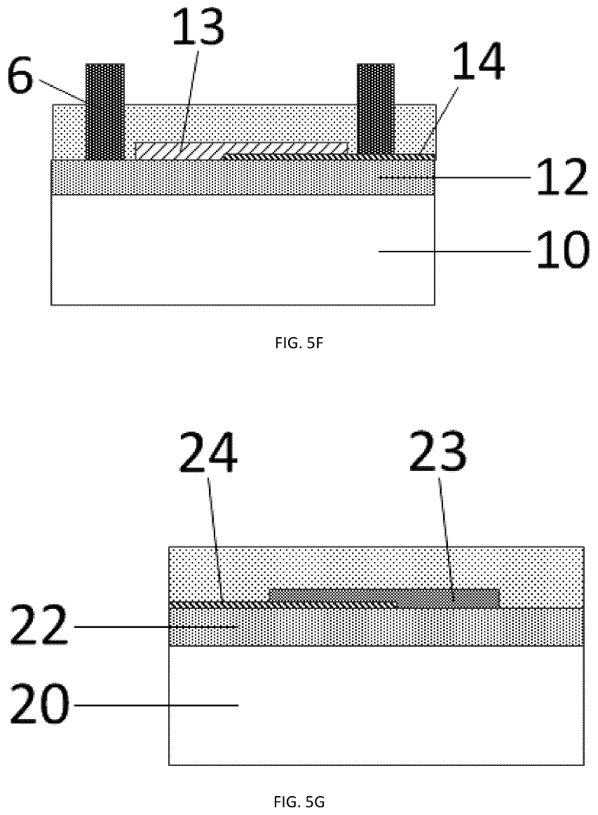

In specific implementations, as illustrated in FIGS. 2 and 3, in the phase shifter provided in the embodiments of the disclosure, the first electrode layer 13 can be a ground electrode set over the entire surface, and the second electrode layer 23 can include micro-strip line(s) 231 as shown in FIG. 7. In this way, the micro-strip line(s) 231 and the ground electrode form a transmission structure for microwave signals, allowing it to transmit (receive and send) microwave signals, and apply a driving voltage through the second voltage line 24. The first voltage line 14 serves as a common voltage line to receive the common voltage. The phase shifter provided in the embodiments can have multiple micro-strip lines 231.

It should be noted that the disclosure is not limited to the micro-strip line of the shape shown in FIG. 7, but can adopt the micro-strip line of any shape, such as a spiral-shaped micro-strip line.

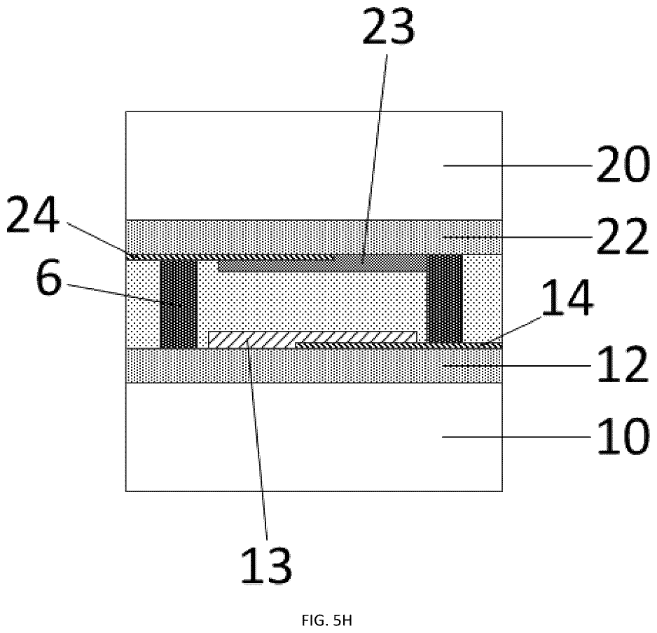

In specific implementations, to expand the application scenarios of liquid crystal phase shifters and liquid crystal phased arrays, for example, in some decorative scenarios where beam scanning functionality is required without compromising aesthetics, such as installation on car sunroofs or building windows, for dynamic connection to 5G base station signals, transparency of the phase shifter is necessary. Therefore, in the phase shifter provided in the embodiments of the disclosure, as shown in FIG. 8, the micro-strip line 231 has a grid-like structure. This enables the transparency of the liquid crystal phase shifter, allowing it to be applied in more scenarios.

In specific implementations, for phase shifter structures based on micro-strip line(s), considering the driving mechanism of the liquid crystal phase shifter, which involves applying voltages to the first electrode layer and the second electrode layer, and taking into account the edge effects of the direct-current (DC) electric field, in the phase shifter provided in the embodiments of the disclosure, as shown in FIG. 8, a spacing between grid lines of the grid-like structure is less than or equal to 100 μm, to ensure that the liquid crystal below the grid lines can deflect under voltage drive.

Specifically, this disclosure does not limit the shape of the grid-like structure mentioned above to any specific shape; and it can be square, rectangular, hexagonal, rhombic, or any other shape. Thinner grid lines are preferable, with the width of the grid line preferably ranging from 1 μm to 20 μm.

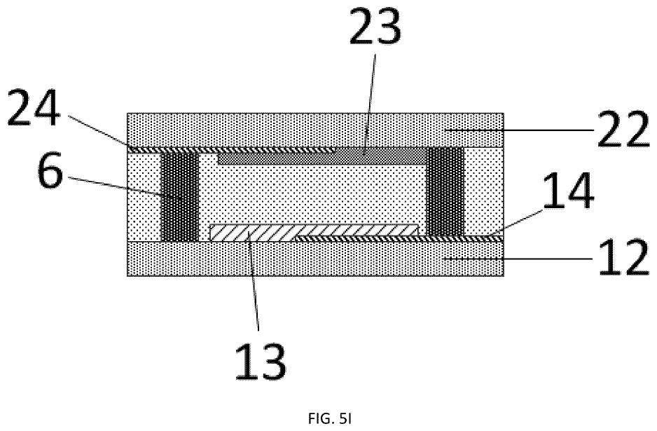

In specific implementations, to adjust the capacitance value of the overlap between the micro-strip line(s) 231 and the ground electrode or the deflection of the liquid crystal as much as possible, in the phase shifter provided in the embodiments of the disclosure, as shown in FIGS. 2 and 3, when the first electrode layer 13 is set as a ground electrode over the entire surface and the second electrode layer 23 includes the micro-strip line(s) 231 as shown in FIG. 7, as shown in FIG. 9 which schematically shows a plan view of the micro-strip line 231, the phase shifter may further include a first transparent conducting layer 7 at a side of the second electrode layer 23 facing or facing away from the first electrode layer 13 and in contact with the second electrode layer 23. An orthographic projection of the first transparent conducting layer 7 on the second base 21 covers an orthographic projection of the micro-strip line 231 on the second base 21. By providing the first transparent conducting layer 7 covering the surface of the micro-strip line(s) 231, on one hand, the transmittance of the phase shifter is not affected, and on the other hand, the overlap area between the micro-strip line(s) 231 and the ground electrode can be increased. Therefore, the surface of the micro-strip line(s) of the grid-like structure that needs adjustment is covered with a first transparent conducting layer 7 that does not affect the transmittance of the phase shifter, such as ITO, boron-doped zinc oxide (BZO), aluminum-doped zinc oxide (AZO), etc., to ensure sufficient control of the overlap capacitance corresponding to the liquid crystal layer 3.

In specific implementations, as shown in FIGS. 2, 3, and 7-9, the liquid crystal phase shifter based on the micro-strip line structure has the liquid crystal cell with a preferred thickness range of 40 μm to 250 μm.

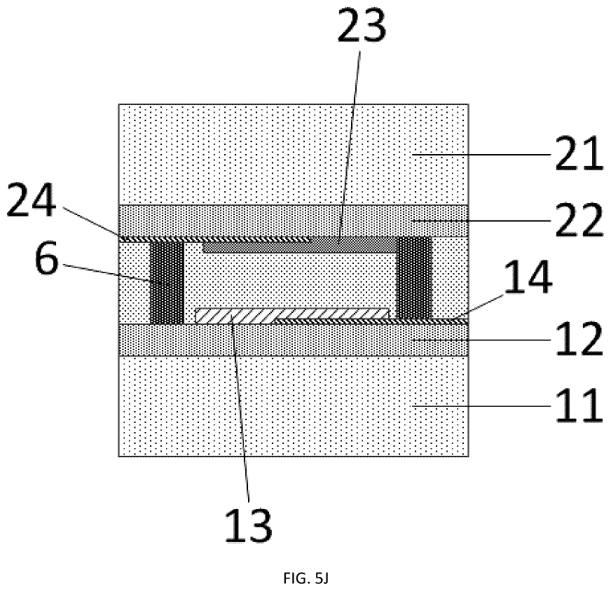

In specific implementations, as shown in FIGS. 2, 3, and 10, in the phase shifter provided in the embodiments of the disclosure, FIG. 10 illustrates a plan view of the first electrode layer 13 and the second electrode layer 23 in FIGS. 2 and 3. The first electrode layer 13 includes a first ground electrode 131, a first signal electrode 132, and a second ground electrode 133 extending along the first direction X and spaced apart along the second direction Y. The second electrode layer 23 includes a plurality of second signal electrodes 232 extending along the second direction Y and spaced apart along the first direction X. An orthographic projection of each second signal electrode 232 on the first base 11 at least partially overlaps with an orthographic projection of the first ground electrode 131 on the first base 11, and at least partially overlaps with an orthographic projection of the second ground electrode 133 on the first base 11. Specifically, due to the partial overlap of the orthographic projection of the second signal electrode 232 with the orthographic projections of the first ground electrode 131 and the second ground electrode 133 on the first base 11, there is a certain overlap between the second signal electrode 232 and the first signal electrode 132 located between the first ground electrode 131 and the second ground electrode 133. Thus, when a microwave signal is input to the first signal electrode 132, a voltage difference between the first signal electrode 132 and the second signal electrode 232 forms an electric field, causing the liquid crystal molecules in the liquid crystal layer 3 to deflect, thereby changing the dielectric constant of the liquid crystal layer 3 and further altering the phase of the microwave signal transmitted through the liquid crystal layer 3.

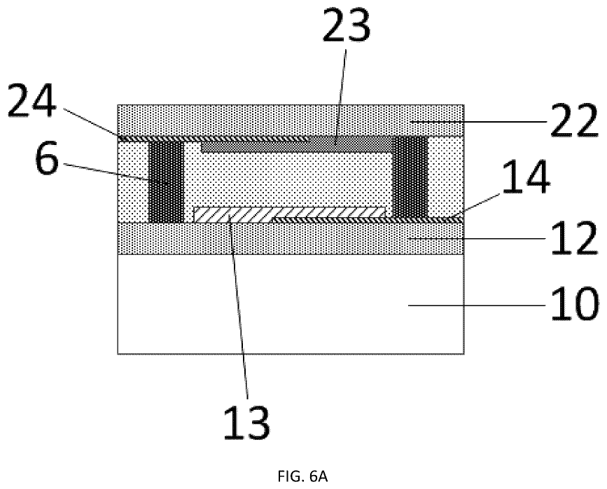

In specific implementations, to improve the transparency of the phase shifter, in the phase shifter provided in the embodiments of the disclosure, as shown in FIG. 11, the first ground electrode 131, the first signal electrode 132, the second ground electrode 133, and the second signal electrode 232 all have a grid-like structure. This enables the transparency of the liquid crystal phase shifter, allowing it to be applied in more scenarios.

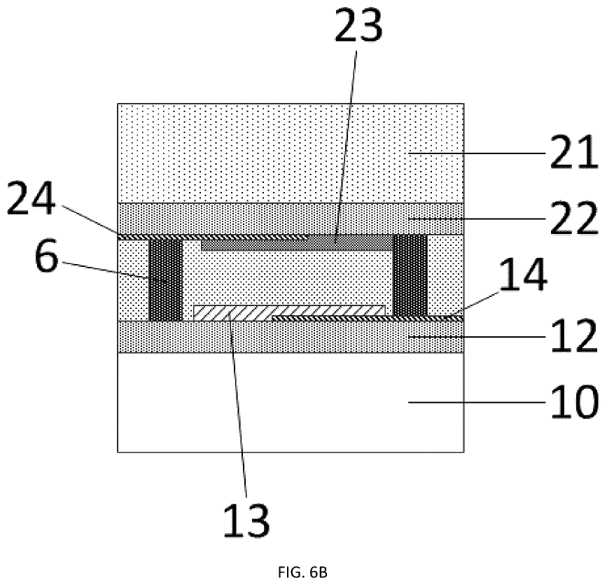

In specific implementations, in the phase shifter provided in the embodiments of the disclosure, as shown in FIGS. 11 and 12, where FIG. 12 is an enlarged view of the dashed box A in FIG. 11, mesh openings of each grid-like structure have the same size, and the grid lines of each grid-like structure have the same width. This further enhances the transparency of the phase shifter.

In specific implementations, in the phase shifter provided in the embodiments of the disclosure, as shown in FIGS. 11 and 12, mesh openings of the second signal electrode 232 in the overlapping region correspond to mesh openings of the first ground electrode 131 in the overlapping region in a one-to-one manner, mesh openings of the second signal electrode 232 in the overlapping region correspond to mesh openings of the second ground electrode 133 in the overlapping region in a one-to-one manner, and mesh openings of the second signal electrode 232 in the overlapping region correspond to mesh openings of the first signal electrode 132 in the overlapping region in a one-to-one manner. This optimizes the transparency of the phase shifter.

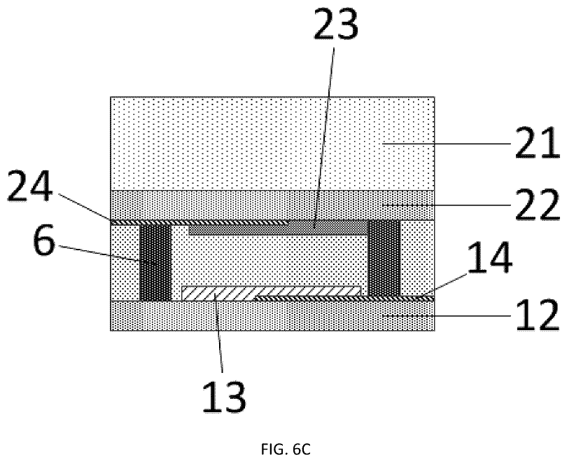

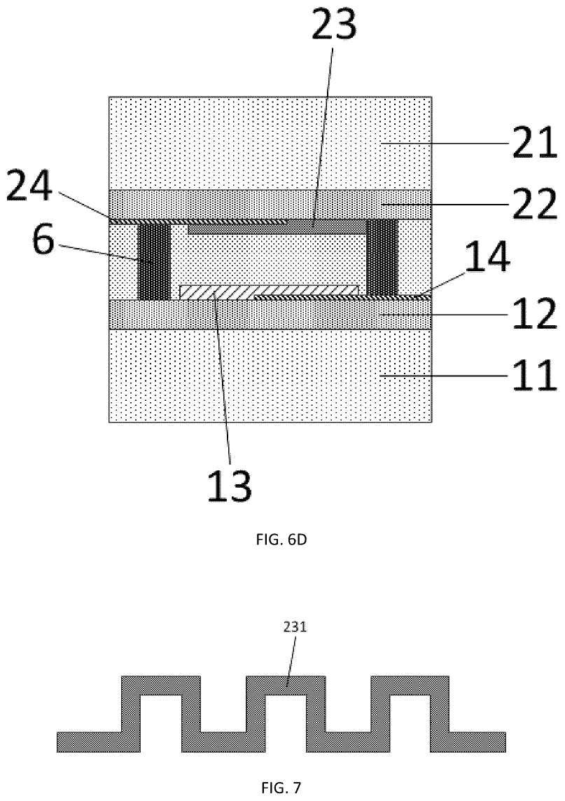

In specific implementations, to increase the amount of phase shift of the phase shifter and ensure fully driving of the liquid crystal corresponding to the overlap capacitance region, in the phase shifter provided in the embodiments of the disclosure, as shown in FIGS. 13 and 14, where FIG. 14 is an enlarged view of the dashed box B in FIG. 13, a mesh density in the overlapping region (dashed box B) between the second signal electrode 232 and the first signal electrode 132 is greater than or equal to a mesh density in other regions.

Specifically, as shown in FIGS. 13 and 14, in regions outside the overlapping region (dashed box B), to maximize transparency, the grids of the first ground electrode 131, the first signal electrode 132, the second ground electrode 133, and the second signal electrode 232 should overlap as much as possible to prevent a decrease in transmittance due to misalignment.

In specific implementations, in the phase shifter provided in the embodiments of the disclosure, as shown in FIGS. 13 and 14, a spacing between the grid lines in regions outside the overlapping region (dashed box B) is less than or equal to 100 μm, and a spacing between the grid lines in the overlapping region (dashed box B) between the second signal electrode 232 and the first signal electrode 132 is less than 20 μm, ensuring fully driving of the liquid crystal corresponding to the overlapping region.

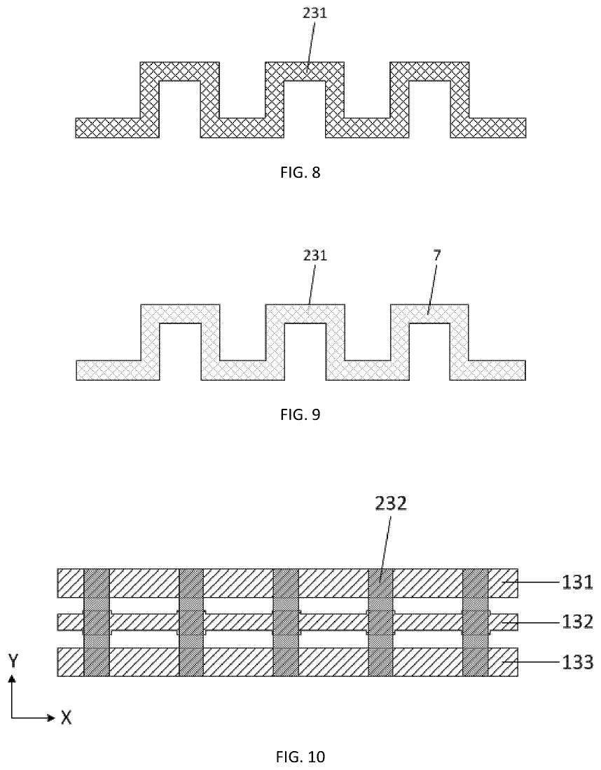

In specific implementations, in the phase shifter provided in the embodiments of the disclosure, as shown in FIGS. 2, 3, and 15, where FIG. 15 is another plan view of the first electrode layer 13 and the second electrode layer 23 in FIGS. 2 and 3, an orthographic projection of the second signal electrode 232 on the first base 11 and an orthographic projection of the first signal electrode 132 on the first base 11 have an overlapping region B.

The phase shifter further includes: a second transparent conducting layer 8 at a side of the first signal electrode 132 facing or facing away from the second electrode layer 23 and in contact with the first signal electrode 132. An orthographic projection of the second transparent conducting layer 8 on the first base 11 covers an orthographic projection of the overlapping region B on the first base 11.

The phase shifter further includes: a third transparent conducting layer 9 at a side of the second signal electrode 232 facing or facing away from the first electrode layer 13 and in contact with the second signal electrode 232. An orthographic projection of the third transparent conducting layer 9 on the first base 11 covers an orthographic projection of the overlapping region B on the first base 11. Thus, by arranging a transparent conducting layer above or under the first signal electrode 132 in the overlapping region B and a transparent conducting layer above or under the second signal electrode 232 in the overlapping region B, the transparency of the phase shifter is not affected while increasing the overlap area between the first signal electrode 132 and the second signal electrode 232 in the overlapping region B. Therefore, covering the surface of the signal electrode of the grid-like structure that needs adjustment with a transparent conducting layer that does not affect the transmittance of the phase shifter, such as ITO, BZO, AZO, etc., ensures sufficient control of the overlap capacitance corresponding to the liquid crystal layer 3.

It should be noted that FIG. 15 illustrates an example of setting the second transparent conducting layer 8 and the third transparent conducting layer 9 in the overlapping region B in FIG. 11, and the second transparent conducting layer 8 and the third transparent conducting layer 9 can also be set in the overlapping region B in FIG. 13.

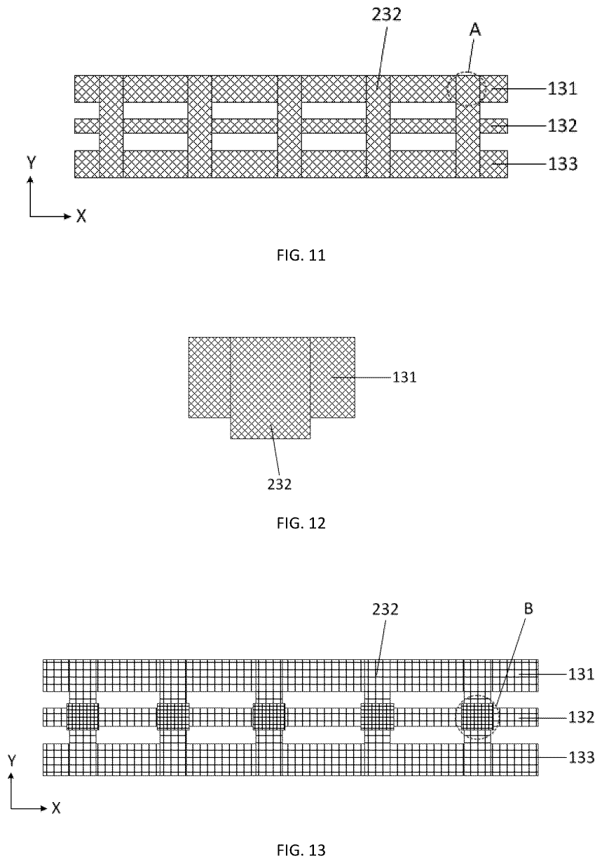

In specific implementations, to ensure that the amount of the phase shift of the phase shifter be consistent with that in a case that the electrodes are in the non-transparent state, in the phase shifter provided in the embodiments of the disclosure, as shown in FIGS. 2, 3, and 16, where FIG. 16 is another plan view of the first electrode layer 13 and the second electrode layer 23 in FIGS. 2 and 3, the second signal electrode 232 and the first signal electrode 132 are not hollowed-out in the overlapping region B. This ensures that the size of the overlap capacitance is consistent with that in a case that the electrodes are in the non-transparent state, thereby increasing the amount of phase shift of the phase shifter.

It should be noted that FIG. 16 illustrates an example of setting the second signal electrode 232 and the first signal electrode 132 in FIG. 11 as non-hollowed-out structures in the overlapping region B. Of course, the second signal electrode 232 and the first signal electrode 132 in FIG. 13 can be set as non-hollowed-out structures in the overlapping region B.

In specific implementations, as shown in FIGS. 2, 3, 10, 11, 13, 15, and 16, for the liquid crystal phase shifter employing a co-planar waveguide transmission line structure, the preferred thickness range of the liquid crystal cell is 3 μm to 40 μm.

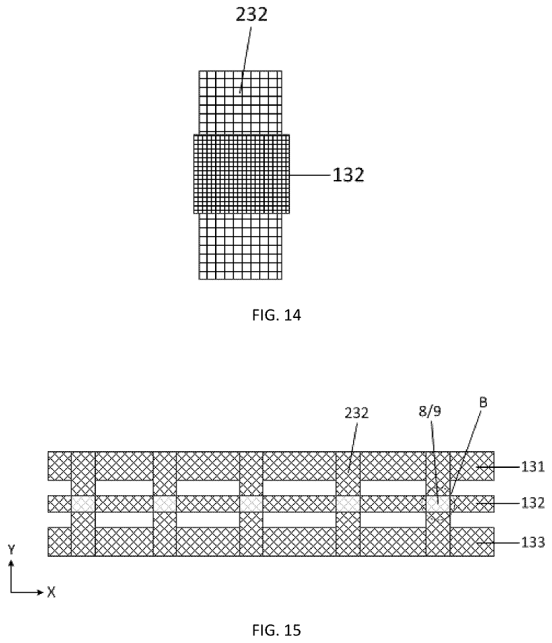

In specific implementations, in the phase shifter provided in the embodiments of the disclosure, as shown in FIGS. 2, 3, 17, where FIG. 17 illustrates another plan view of the first electrode layer 13 and the second electrode layer 23 in FIGS. 2 and 3, the first electrode layer 13 includes a first differential transmission line 134 and a second differential transmission line 135 extending along the first direction X and spaced apart along the second direction Y, and the second electrode layer 23 includes a plurality of signal electrodes 233 extending along the second direction Y and spaced apart along the first direction X. An orthographic projection of each signal electrode 233 on the first base 11 at least partially overlaps with an orthographic projection of the first differential transmission line 134 on the first base 11, and at least partially overlaps with an orthographic projection of the second differential transmission line 135 on the first base 11. Specifically, the first differential transmission line 134 includes a first main structure 1341 and a plurality of first branches 1342 connected with the first main structure 1341 and spaced apart at a side of the first main structure 1341 facing the second differential transmission line 135. The second differential transmission line 135 includes a second main structure 1351 and a plurality of second branches 1352 connected with the second main structure 1351 and spaced apart at a side of the second main structure 1351 facing the first differential transmission line 134. The first branches 1342 correspond to the second branches 1352 in a one-to-one manner, and the orthographic projection of each signal electrode 233 on the first base 11 covers orthographic projections of a pair of first branch 1342 and second branch 1352 on the first base 11. Thus, the first differential transmission line 134 and the second differential transmission line 135 can be connected and led out through a first ITO lead, and multiple signal electrodes 233 can be connected and led out through a second ITO lead. Due to a voltage difference between the first and second ITO leads, an electric field is formed, allowing microwave signals to be transmitted between the first differential transmission line 134 and the second differential transmission line 135, thereby causing the liquid crystal molecules in the liquid crystal layer 3 to deflect, changing the dielectric constant of the liquid crystal layer 3, and altering the phase of the microwave signals transmitted in the liquid crystal layer 3.

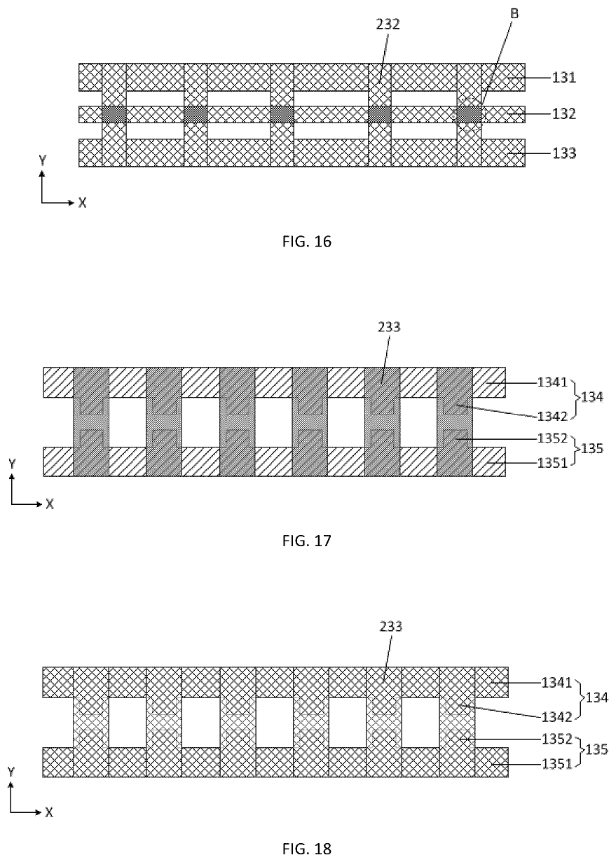

In specific implementations, to enhance the transparency of the phase shifter employing the structure shown in FIG. 17, in the phase shifter provided in the embodiments of the disclosure, as shown in FIG. 18, at least one of the first differential transmission line 134, the second differential transmission line 135, or the signal electrode 233 has a grid-like structure. The disclosure takes the first differential transmission line 134, the second differential transmission line 135, and the signal electrode 233 all including a grid-like structure as an example, which enables the transparency of the liquid crystal phase shifter, allowing it to be applied in more scenarios.

In specific implementations, in the phase shifter provided in the embodiments of the disclosure, as shown in FIG. 18, mesh openings of each grid-like structure have the same size, and the grid lines of each grid-like structure have the same width. This further enhances the transparency of the phase shifter.

In specific implementations, in the phase shifter provided in the embodiments of the disclosure, as shown in FIGS. 2, 3, 17, and 18, for the liquid crystal phase shifter employing a differential transmission line structure, the preferred thickness range of the liquid crystal cell is 3 μm to 40 μm.

It should be noted that the disclosure illustrates specific structures of the first electrode layer and the second electrode layer of the phase shifter, but is not limited thereto. However, using low dielectric constant layers and flexible layers for both the first and second substrates can significantly improve the tuning efficiency and reduce losses of the phase shifter, and achieve an extremely low-profile phase shifter.

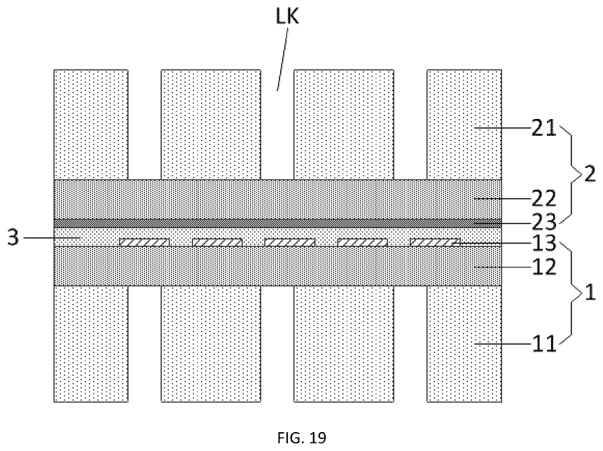

In specific implementations, in the phase shifter provided in the embodiments of the disclosure, as shown in FIG. 19, both the first base 11 and the second base 21 may have at least one hollowed-out structure LK. By designing the low dielectric constant layers (first base 11 and second base 21) that serve as support substrates to be hollowed out, for the coupling of the microwave signals, merely air is passed through, further reducing dielectric losses and improving the antenna radiation efficiency and bandwidth.

Specifically, the use of grid-like electrode layers in the phase shifter provided herein can achieve transparency of the phase shifter. Since the first flexible substrate and the second flexible substrate can be made of materials such as PI, COP, PET, etc., which are highly transparent, the first flexible substrate and the second flexible substrate have high transparency. The requirement for the first base and the second base is that their dielectric constants should be as close to air as possible. Therefore, by using grid-like electrode layers, a certain degree of transparency can be achieved, and the hollowed-out structures of the first base and the second base are more conducive to reducing the equivalent dielectric constant, thereby achieving transparency of the phase shifter and improving its performance.

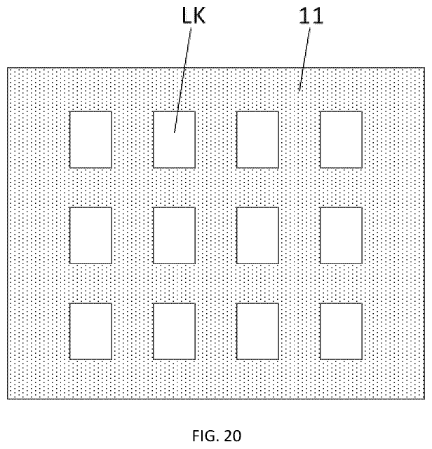

In specific implementations, in the phase shifter provided in the embodiments of the disclosure, as shown in FIG. 19, both the first base 11 and the second base 21 have a plurality of hollowed-out structures LK, which can be uniformly distributed. As shown in FIG. 20, a plan view of the hollowed-out structure LK of the first base 11 is illustrated by taking the first base 11 as an example.

Optionally, a size of the hollowed-out structure is comparable to or slightly larger than a size of the part for the microwave signal coupling. Of course, other parts that do not affect the transmission of the microwave signal can also be designed with hollowed-out structures.

It should be noted that FIG. 19 illustrates an example of setting hollowed-out structures LK in the first base 11 and the second base 21 in FIG. 1. Of course, hollowed-out structures LK can be set in the first base 11 and the second base 21 in FIGS. 2 and 3.

In specific implementations, the aforementioned phase shifter may further include other functional film layers known to those skilled in the art, which are not listed here.

Based on the same inventive concept, embodiments of the disclosure further provide an antenna, including any one of the phase shifters provided in the embodiments of the disclosure. The implementation of the antenna can refer to the embodiments of the phase shifter described above, and redundant descriptions are omitted.

It should be noted that the number of phase shifters included in the antenna is determined according to actual needs, which is not limited in the embodiments of the disclosure.

The embodiments of the disclosure provide a phase shifter and an antenna. Both the first substrate and the second substrate adopt low dielectric constant layers and flexible layers. On the one hand, since the dielectric constant of low dielectric constant materials is usually close to that of air, for microwave signals, the equivalent dielectric constant depends largely on the dielectric layer, thereby greatly improving the tuning efficiency of the phase shifter. On the other hand, the loss of low dielectric constant layers is much lower than that of materials such as glass and PCB, resulting in extremely low dielectric losses during transmission. Therefore, the tuning efficiency of the phase shifter provided by the embodiments of the disclosure can be greatly improved, and the loss can be greatly reduced. Using low-loss phase shifters can avoid the use of waveguide structures, greatly reduce the weight and longitudinal size of the antenna array, and achieve an extremely low-profile phase shifter.

Although preferred embodiments of the disclosure have been described, additional changes and modifications may be made to these embodiments once the basic creative concepts are known to those skilled in the art. Accordingly, the appended claims are intended to be construed to include the preferred embodiments and all changes and modifications falling within the scope of the disclosure.

Obviously, those skilled in the art may make various changes and variations to the disclosure without deviating from the spirit and scope of the disclosure. Thus, if these modifications and variations of the disclosure are within the scope of the claims of the disclosure and their equivalents, the disclosure is also intended to include such modifications and variations.

1. A phase shifter, comprising a first substrate and a second substrate arranged opposite to each other, and a dielectric layer between the first substrate and the second substrate; wherein,
the first substrate comprises: a first base, a first flexible substrate at a side of the first base close to the dielectric layer, and a first electrode layer at a side of the first flexible layer close to the dielectric layer;
the second substrate comprises: a second base, a second flexible substrate at a side of the second base close to the dielectric layer, and a second electrode layer at a side of the second flexible layer close to the dielectric layer; and
a dielectric constant of the first base and a dielectric constant of the second base both are smaller than or equal to 1.5.

2. The phase shifter according to claim 1, wherein the first substrate further comprises a first voltage line between the first flexible substrate and the first electrode layer, and the second substrate further comprises a second voltage line between the second flexible substrate and the second electrode layer;
wherein the first voltage line is electrically connected with the first electrode layer, and the second voltage line is electrically connected with the second electrode layer.

3. The phase shifter according to claim 2, wherein a material of the first voltage line and a material of the second voltage line both are a transparent conducting material;
the first voltage line is electrically connected with the first electrode layer via direct contact; and
the second voltage line is electrically connected with the second electrode layer via direct contact.

4. The phase shifter according to claim 3, wherein the first voltage line is electrically connected with the first electrode layer at edges of both, and a width of an overlap between an orthographic projection of the first voltage line on the first base and an orthographic projection of the first electrode layer on the first base is larger than 1 μm; and
the second voltage line is electrically connected with the second electrode layer at edges of both, and a width of an overlap between an orthographic projection of the second voltage line on the second base and an orthographic projection of the second electrode layer on the second base is larger than 1 μm.

5. The phase shifter according to claim 2, wherein a material of the first voltage line and a material of the second voltage line both are metal;
wherein the first substrate further comprises a first insulating layer between the first voltage line and the first electrode layer, and the second substrate further comprises a second insulating layer between the second voltage line and the second electrode layer;
wherein the first voltage line is electrically connected with the first electrode layer through a first via hole passing through the first insulating layer, and the second voltage line is electrically connected with the second electrode layer through a second via hole passing through the second insulating layer;
wherein a shape of the first via hole and a shape of the second via hole both are annular.

6. (canceled)

7. The phase shifter according to claim 1, wherein the first electrode layer is ground electrode set over an entire surface, and the second electrode layer comprises a micro-strip line;
wherein the micro-strip line has a grid-like structure.

8. (canceled)

9. The phase shifter according to claim 7, wherein a spacing between grid lines of the grid-like structure is less than or equal to 100 μm, and a width of the grid line ranges from 1 μm to 20 μm.

10. The phase shifter according to claim 7, further comprising: a first transparent conducting layer at a side of the second electrode layer facing or facing away from the first electrode layer and in contact with the second electrode layer;
wherein an orthographic projection of the first transparent conducting layer on the second base covers an orthographic projection of the micro-strip line on the second base.

11. The phase shifter according to claim 1, wherein the first electrode layer comprises a first ground electrode, a first signal electrode, and a second ground electrode extending along a first direction and spaced apart along a second direction;
the second electrode layer comprises a plurality of second signal electrodes extending along the second direction and spaced apart along the first direction; and
an orthographic projection of each of the plurality of second signal electrodes on the first base at least partially overlaps with an orthographic projection of the first ground electrode on the first base, and at least partially overlaps with an orthographic projection of the second ground electrode on the first base.

12. The phase shifter according to claim 11, wherein the first ground electrode, the first signal electrode, the second ground electrode, and the second signal electrode all comprise a grid-like structure.

13. The phase shifter according to claim 12, wherein mesh openings of each grid-like structure have a same size, and grid lines of each grid-like structure have a same width.

14. The phase shifter according to claim 12, wherein a mesh density in an overlapping region between the second signal electrode and the first signal electrode is greater than or equal to a mesh density in other regions.

15. The phase shifter according to claim 14, wherein a spacing between grid lines in the overlapping region between the second signal electrode and the first signal electrode is less than 20 μm.

16. The phase shifter according to claim 12, wherein the orthographic projection of the second signal electrode on the first base and an orthographic projection of the first signal electrode on the first base have the overlapping region;
the phase shifter further comprises: a second transparent conducting layer at a side of the first signal electrode facing or facing away from the second electrode layer and in contact with the first signal electrode; wherein an orthographic projection of the second transparent conducting layer on the first base covers an orthographic projection of the overlapping region on the first base; and
the phase shifter further comprises: a third transparent conducting layer at a side of the second signal electrode facing or facing away from the first electrode layer and in contact with the second signal electrode; wherein an orthographic projection of the third transparent conducting layer on the first base covers the orthographic projection of the overlapping region on the first base.

17. The phase shifter according to claim 14, wherein the second signal electrode and the first signal electrode are not hollowed-out in the overlapping region.

18. The phase shifter according to claim 1, wherein the first electrode layer comprises a first differential transmission line and a second differential transmission line extending along a first direction and spaced apart along a second direction;
the second electrode layer comprises a plurality of signal electrodes extending along the second direction and spaced apart along the first direction; and
an orthographic projection of each of the plurality of signal electrodes on the first base at least partially overlaps with an orthographic projection of the first differential transmission line on the first base, and at least partially overlaps with an orthographic projection of the second differential transmission line on the first base.

19. The phase shifter according to claim 18, wherein the first differential transmission line comprises a first main structure and a plurality of first branches connected with the first main structure and spaced apart at a side of the first main structure facing the second differential transmission line;
the second differential transmission line comprises a second main structure and a plurality of second branches connected with the second main structure and spaced apart at a side of the second main structure facing the first differential transmission line;
the plurality of first branches correspond to the plurality of second branches in a one-to-one manner; and
the orthographic projection of each of the plurality of signal electrodes on the first base at least covers orthographic projections of a pair of first branch and second branch on the first base;
wherein at least one of the first differential transmission line, the second differential transmission line, or the signal electrode comprises a grid-like structure.

20. (canceled)

21. The phase shifter according to claim 1, wherein
both the first base and the second base have at least one hollowed-out structure; or
both the first base and the second base have a plurality of hollowed-out structures distributed uniformly.

22. The phase shifter according to claim 1, wherein
a material of the first base and a material of the second base both comprise polymethacrylimide (PMI); and/or,
wherein a thickness of the first base and a thickness of the second base both range from 0.5 mm to 3 mm; and/or,
wherein a material of the first flexible substrate and a material of the second flexible substrate comprise polyimide (PI), cycloolefin polymers (COP), or polyethylene terephthalate (PET); and/or,
wherein a thickness of the first flexible substrate and a thickness of the second flexible substrate both range from 1 μm to 20 μm.

23. (canceled)

24. (canceled)

25. (canceled)

26. An antenna comprising the phase shifter according to claim 1.
